(19) United States
(12) Patent Application Publication
(10) Pub. No.: US 2025/0162122 A1
(43) Pub. Date: May 22, 2025

(54) POWER TOOL

(71) Applicant: Black & Decker Inc., New Britain, CT (US)

(72) Inventors: Jian Hua CHEN, Suzhou (CN); Guo Qing WANG, Suzhou (CN); Hai Rong He, Suzhou (CN); Joseph Patrick Kelleher, Towson, MD (US)

(73) Assignee: Black & Decker Inc., New Britain, CT (US)

(21) Appl. No.: 18/939,050

(22) Filed: Nov. 6, 2024

Related U.S. Application Data
(60) Provisional application No. 63/600,213, filed on Nov. 17, 2023.

(51) Int. Cl. B25F 5/00; B25D 11/10; B25D 16/00; B25F 5/02

(52) U.S. Cl. CPC B25F 5/001; B25D 11/102; B25D 16/003; B25F 5/02

(57) ABSTRACT

A hammer drill includes a tool housing including a motor housing portion; a motor in the motor housing portion; an output spindle driven by the motor; a clutch housing; and a hammering mechanism including a first ratchet and a second ratchet. The hammering mechanism is configured to impart axial impacts to the output spindle. The hammer drill further includes an insert in the clutch housing. The insert includes a body and a plurality of legs extending from the body.

### CROSS-REFERENCE TO RELATED APPLICATIONS

This application claims benefit of Provisional Patent Application No. 63/600,213 filed Nov. 17, 2023, The entire contents of which are incorporated herein by reference.

### BACKGROUND

The present disclosure relates to power tools, for example a hammer drill, and heat resistant materials or inserts for user in power tools.

### SUMMARY

Aspects of the present disclosure relate to example embodiments of a power tool, for example, a hammer drill tool.

According to an aspect, an example embodiment of an hammer drill includes: a tool housing comprising a motor housing portion; a motor in the motor housing portion; an output spindle driven by the motor; a clutch housing; a hammering mechanism comprising a first ratchet and a second ratchet, the hammering mechanism configured to impart axial impacts to the output spindle; and an insert in the clutch housing. The insert comprises a body and a plurality of legs extending from the body.

The clutch housing may include a first material with a first melting point.

The insert may include a second material with a second melting point.

The second melting point may be higher than the first melting point.

The second melting point may be at least 100 degrees Celsius higher than the first melting point.

The second melting point may be at least 200 degrees Celsius higher than the first melting point.

The second melting point may be at least 400 degrees Celsius higher than the first melting point.

The clutch housing may include a longitudinally extending groove.

The insert may form at least a part of a sidewall of the groove.

The clutch housing may include a longitudinally extending groove.

The insert may cover at least a part of a sidewall of the groove.

The first ratchet may be rotationally fixed relative to the clutch housing.

The plurality of legs may extend in a forward direction to an area adjacent to the first ratchet.

The plurality of legs may have a projection length of at least five millimeters.

According to an aspect, an example embodiment of a hammer drill includes: a tool housing comprising a motor housing portion; a motor in the motor housing portion; an output spindle driven by the motor; a clutch housing; a hammering mechanism comprising a first ratchet rotationally fixed relative to the clutch housing and a second ratchet fixed to the output spindle, the hammering mechanism configured to impart axial impacts to the output spindle; an insert in the clutch housing.

The clutch housing may include a first material with a first melting point.

The insert may include a second material with a second melting point.

The second melting point may be at least 200 degrees Celsius greater than the first melting point.

At least a portion of the insert may be in an area adjacent to the first ratchet.

The fixed ratchet may include a fixed ratchet projection, the fixed ratchet projection extending radially outwardly and configured to limit radial movement of the fixed ratchet.

At least a portion of the insert may be in an area adjacent to the fixed ratchet projection.

The clutch housing may include a longitudinally extending groove.

The insert may form at least a part of a sidewall of the groove.

The hammer drill may also include a cam ring behind the first rachet.

At least a portion of the insert may be in an area behind the cam ring.

The insert may include a generally cylindrical body and at least one projection that projects forward from the generally cylindrical body.

The generally cylindrical body may be around a portion of the output spindle.

The insert may be made of at least one of powdered metal or sheet metal.

According to an aspect, an example embodiment of a hammer drill includes: a tool housing comprising a motor housing portion; a motor in the motor housing portion; an output spindle driven by the motor; a clutch housing; a hammering mechanism comprising a cam ring, a first ratchet rotationally fixed relative to the clutch housing, and a second ratchet fixed to the output spindle, the hammering mechanism configured to impart axial impacts to the output spindle; and an insert in the clutch housing.

The insert may include a generally cylindrical body and a projection extending forward from the generally cylindrical body with a projection length of at least five millimeters.

The generally cylindrical body may be around a portion of the output spindle and behind the cam ring.

The at least one projection may extend forward at least as far as the first ratchet.

The at least one projection may include a plurality of legs.

The clutch housing may include a first material with a first melting point.

The insert may include a second material with a second melting point.

The second melting point may be at least 200 degrees Celsius greater than the first melting point.

The clutch housing may include a longitudinally extending groove.

The projection of the insert may form at least a part of a sidewall of the groove.

The fixed ratchet may include a ratchet projection and the ratchet projection engages the longitudinally extending groove.

These and other aspects of various embodiments, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures.

### BRIEF DESCRIPTION OF THE DRAWINGS

Example embodiments of the present application are described with reference to and in conjunction with the accompanying drawings, in which:

FIG. 1 is side view of a hammer drill according to an exemplary embodiment;

FIG. 2 is a perspective view of a prior art insert;

FIG. 3 is a perspective view of an insert according to an exemplary embodiment;

FIG. 4 is a perspective view of an insert according to an exemplary embodiment;

FIG. 5 is a cross-sectional view of an exemplary embodiment of the hammer drill;

FIG. 6 is an explanatory perspective view of a hammer mechanism of an exemplary embodiment of a hammer drill;

FIG. 7 is a perspective view of an exemplary embodiment of a clutch housing and insert;

FIG. 8 is a perspective view of an exemplary embodiment of a clutch housing and insert;

FIG. 9 is a perspective view of an exemplary embodiment of parts of a hammer drill according to an exemplary embodiment including a clutch housing and insert according to an exemplary embodiment;

FIG. 10 is a close-up cross-sectional view of an exemplary embodiment of the hammer drill;

FIG. 11 is a perspective view of another example embodiment of an insert; and

FIG. 12 is a perspective view of an exemplary embodiment of parts of a hammer drill according to an exemplary embodiment including a clutch housing and insert according to an exemplary embodiment.

### DETAILED DESCRIPTION OF EXEMPLARY EMBODIMENTS

The drawings are for the purpose of illustration and description only and are not intended as a definition of the limits of the invention. In addition, it should be appreciated that structural features shown or described in any one embodiment herein can be used in other embodiments as well. As used in the specification and in the claims, the singular form of “a”, “an”, and “the” include plural referents unless the context clearly dictates otherwise.

All closed-ended (e.g., between A and B) and open-ended (greater than C) ranges of values disclosed herein explicitly include all ranges that fall within or nest within such ranges. For example, a disclosed range of 1-10 is understood as also disclosing, among other ranged, 2-10, 1-9, 3-9, etc.

As used herein, the terminology “at least one of A, B and C” and “at least one of A, B and C” each mean any one of A, B or C or any combination of A, B and C. For example, at least one of A, B and C may include only A, only B, only C, A and B, A and C, B and C, or A, B and C.

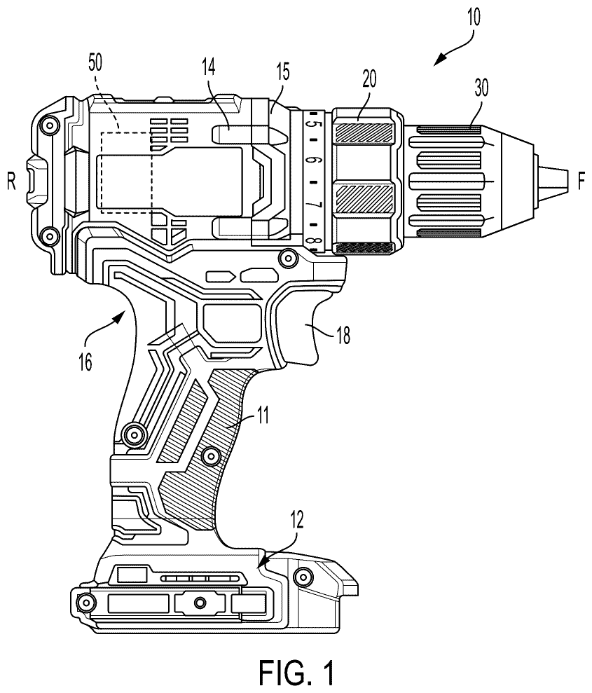

FIG. 1 illustrates an exemplary embodiment of a hammer drill 10. The hammer drill 10 includes a housing 16 including handle portion 11, foot portion 12 and motor housing portion 14. The handle 11 is configured to be grasped by a user so that a user can hold and operate the hammer drill 10. The foot portion 12 is at a bottom of the handle 11. The foot portion 12 is configured to selectively receive a battery pack for powering the hammer drill 10. The battery pack may be a removable and rechargeable power tool battery pack that can be selectively engaged with the hammer drill 10 in order to power the hammer drill 10 or to another tool such as a saw or a sander to power the saw or sander.

The motor housing portion 14 houses a motor 50. The location of the motor 50 is shown in dashed lines in FIG. 1. The hammer drill 10 also includes a gear case housing part 15 which engages with the motor housing portion 14. A clutch collar 20 is forward of the gear case housing part 15 and a chuck 30 is at the front of the hammer drill 10. The chuck 30 may include a plurality of retractable jaws configured to hold a drill bit, screwdriver bit or other output accessory. The motor 50 drives the chuck 30 in a rotary motion through a transmission. User-operable trigger 18 provides for actuation of the motor 50. A front or forward direction of the example embodiment of the power tool 10 is identified as F in FIG. 1 and a back or rearward direction of the power tool 10 is identified by R.

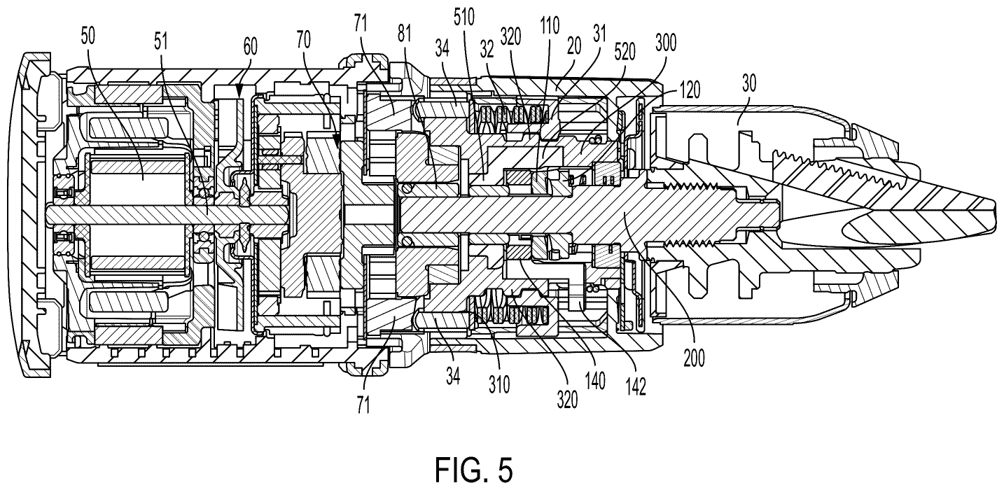

FIG. 5 is a cross sectional view of the hammer drill 10 and shows internals of the hammer drill 10. As shown in FIG. 5, the motor 50 is housed in the motor housing 14 portion of the hammer drill 10. A motor output spindle 51 is rotationally driven by the motor. A motor fan 60 is on the motor output spindle 51. The fan 60 rotates with the motor output spindle 51 and is configured to cool the motor 50. A transmission 70 is driven by the motor 50 via the motor output spindle 51. The transmission may be a multi-stage planetary transmission 70. The transmission 70 may be a two-speed transmission and a user may toggle the transmission between the first and second speeds. In other embodiments, the transmission may be a three-speed transmission or a single speed transmission.

The transmission drives an output spindle 200. The output spindle is attached to the chuck 30. Accordingly, the chuck 30 moves rotationally and axially with the output spindle 200.

Clutch collar 30 is configured to operate the drill clutch, which variably limits torque to the chuck 30. Clutch collar 30 is manually rotatable by a user relative to the motor housing 14, handle 11 and the like. A clutch adjustment ring is operably attached to the clutch collar. The adjustment ring 31 partially holds and compresses a clutch spring 32. The clutch spring 32 is bounded at a rear end of the clutch spring 32 (the end closest to the motor 50) by a plate 33. The clutch spring 32 biases the plate 33 rearwardly (in the direction towards the motor 50). The plate 33 presses against pins 34 and the pins 34 in turn press against ring gears 71 of the transmission 70. As the user rotates the clutch collar 30, the adjustment ring 31 moves relative to clutch housing 300 in a direction of compressing the clutch spring 32 more or less. In the example embodiment, there are a plurality of pins 34 and a plurality of corresponding ring gears 71. In the example embodiment there may be six pins 34 and six ring gears 71.

The pins 34 press against the ring gears 71 with a varying force depending upon the location of the clutch collar 30 and thus the amount of compression on the spring 32. In particular, the more compressed the spring 32, the greater the force on the pins 34 and the more strongly engaged the pins 34 are with the ring gears 71. When the hammer drill 10 is operated, the pins 34 engage with the ring gears 71 so that the ring gears 71 do not rotate relative to the housing 16 and torque is transmitted to the chuck 30. When the torque exceeds a threshold, the ring gears 71 slip out of engagement with the pins 34 and rotate relative to the housing 16 so as to interrupt the transmission of torque to the output spindle 200 and so to the chuck 30. The torque threshold changes depending upon the clutch collar 30, which changes the compression force of the spring 32.

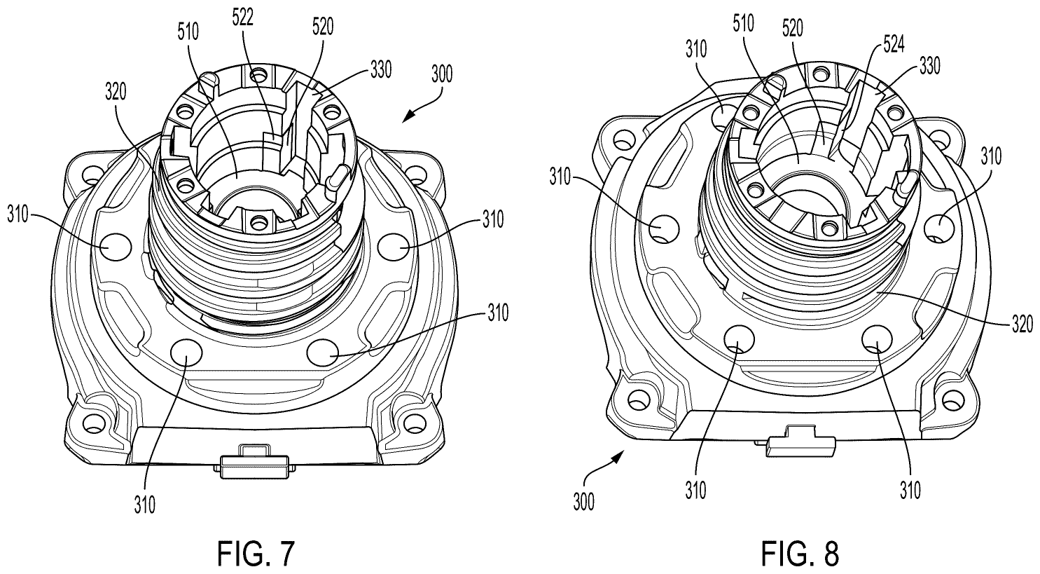

FIGS. 7 and 8 illustrate the clutch housing 300 in more detail. The clutch housing includes a plurality of pin holes 310 for holding the pins 34. The pins 34 may slide axially in the holes 310 and are bounded on one side by the ring gears 71 and on the other side by the plate 33 biased by spring 32. In the example embodiment, the clutch housing 300 includes six pin holes 310. The clutch housing 300 further includes a screw thread 320. The screw thread 320 engages with the clutch adjustment ring 31 so that the clutch adjustment ring 31 can rotate with the clutch collar 30 and move axially to compress the spring 32 to different degrees. The clutch housing 300 also includes three axial grooves 330. The grooves 330 engage with projections 114 of the fixed ratchet 110.

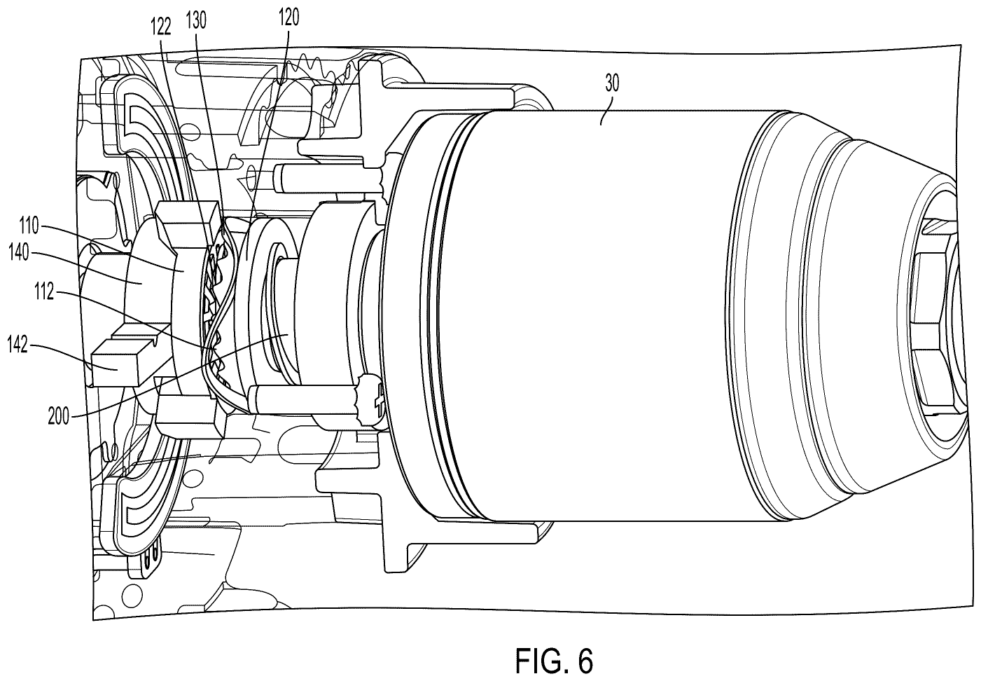

The hammer drill 10 includes a percussive ratchet mechanism that selectively provides for axial movement of the chuck 30 to provide a hammering action in addition to a rotation. As shown in FIGS. 5 and 6, the hammer drill 10 includes a fixed ratchet 110 and a rotating ratchet 120. The rotating ratchet is fixedly connected to the output spindle 200 to rotate with the output spindle. The fixed ratchet 110 remains rotationally stationary relative to the output spindle 200 when the output spindle 200 rotates. A compression spring 130 is disposed between the rotating ratchet 120 and the fixed ratchet 110. The compression spring 130 biases the fixed ratchet 110 away from the rotating ratchet 120. The fixed ratchet 110 and the rotating ratchet 120 each have ratchet teeth 112, 122 that face one another and are configured to selectively engage each other to impart axial impacts to the output spindle 200.

The fixed ratchet 110 has an annual body with radially extending projections 114 that are received in grooves of the clutch housing 300. The projections 114 keep the fixed ratchet rotationally stationary relative to the clutch housing 300 while the fixed ratchet 110 can move axially relative to the output spindle 200 and the clutch housing 300 in the grooves.

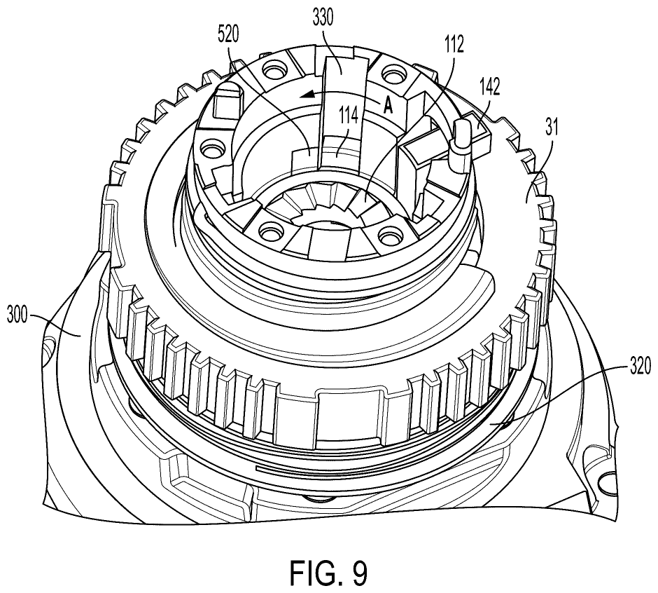

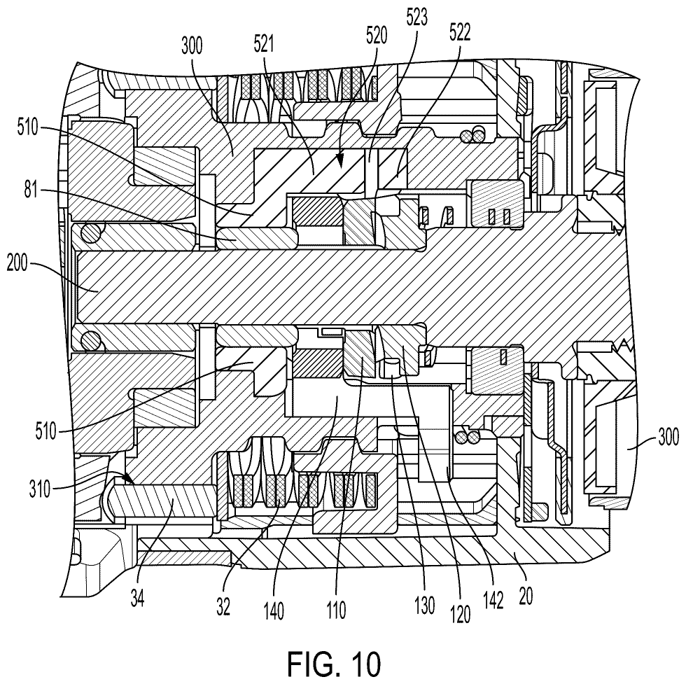

An annular cam plate 140 is disposed behind the fixed ratchet 110. The cam plate 140 includes a leg 142. FIG. 6 illustrates only a radially extending portion of the leg 142 for illustrative purposes. As shown in, for example, FIGS. 9 and 10, the leg 142 also extends further axially and radially so as to project through a portion of the clutch housing 300. The cam plate 140 is configured to selectively move the fixed ratchet 110 forward so as to engage the hammer mechanism of the hammer drill 10. In particular, the clutch collar 30 can be rotated into a position in which the adjustment ring 31 rotates the leg 142, which in turn rotates the cam plate 140. Rotation of the cam plate into a hammering mode position pushes the fixed ratchet 110 forward into a hammer mode position in which the ratchet teeth 112, 122 selectively engage each other to impart axial impacts to the output spindle 200 when the chuck 30 is subject to an axial force.

Rotation of the cam plate 140 out of the hammering mode position allows the fixed ratchet 110 to move rearwardly out of the hammering mode position. When not in the hammering mode position, the fixed ratchet 110 is sufficiently far away from the movable ratchet 120 so that the ratchet teeth do not engage to create axial impacts. Accordingly, a user can rotate the clutch collar 20 to selectively engage the hammer mechanism through rotation of the cam plate 140.

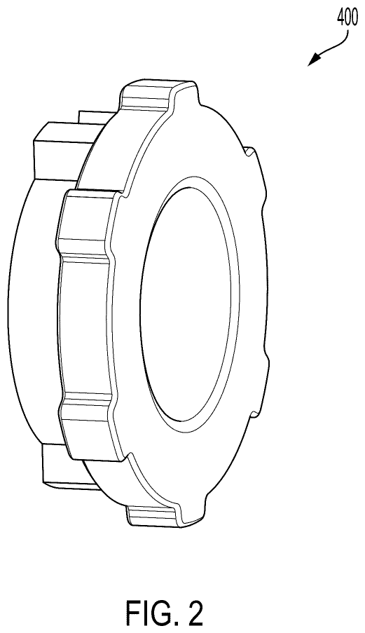

A hammer mechanism may create significant heat which may create heat related issues such as deformation of the clutch housing. A related art hammer drill includes a cylindrical powdered metal insert 400 molded into a clutch housing. The related art insert may alleviate some issues related to the heat. The related art insert 400 shown in FIG. 2 may be representative of an insert in prior art drill DEWALT Drill/Driver/Hammerdrill DC 805 Type 1. The insert 400 includes only a cylindrical body, and the entirety of the insert is located rearwardly of the cam ring such that the insert 400 is remote from the fixed ratchet.

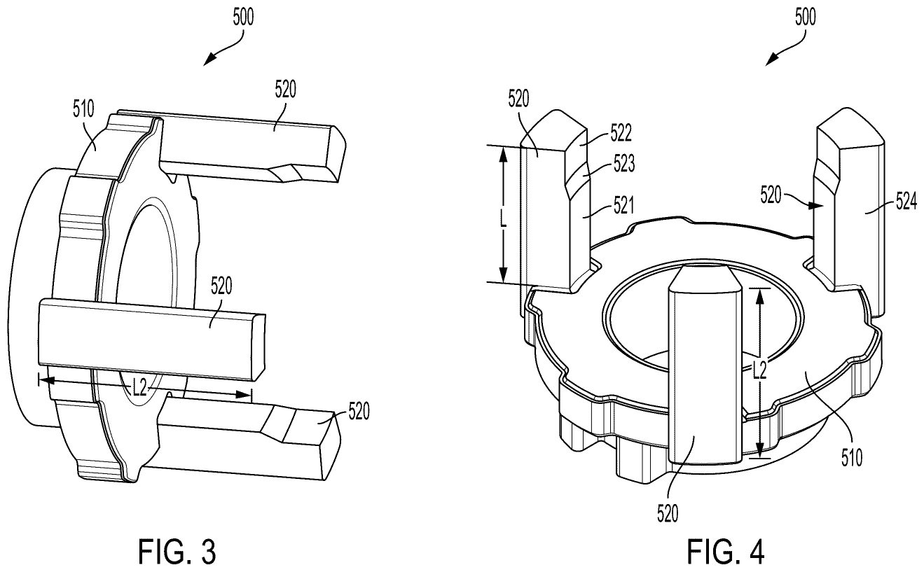

An example embodiment of an insert 500 of the present application is shown in FIGS. 3 and 4. As shown in FIGS. 3 and 4, the insert 500 of the example embodiment includes a generally cylindrical body 510 and a plurality of legs 520 that extend forward from the generally cylindrical body 510. The example embodiment includes three legs 520. Other example embodiments may include a different number of legs. In some embodiments, there may be at least two legs, at least three legs, at least four legs, at least five legs, or at least six legs. There may also be twelve or fewer legs, ten or fewer legs, or eight or fewer legs.

As shown in FIGS. 3 and 4, the legs 520 may include a first portion 521 and a second portion 522, where the first portion 521 is wider than the second portion 522. The legs 520 may include a tapered portion 523 between the first portion 521 and the second portion 522. A side surface 524 of the legs 520 forms part of a groove 330, as will be further described below.

The legs 520 have a projection length L in a direction extending away from the generally cylindrical body 510. The projection length L of the legs may be at least 4 millimeters (mm), at least 5 mm, at least 6 mm, at least 7 mm, at least 8 mm, at least 9 mm, or at least 10 mm. The legs 520 may also have an overall length L2. The overall length L2 may be greater than the length L and the length L2 may be at least 6 mm, at least 7 mm, at least 8 mm, at least 9 mm, at least 10 mm or at least 11 mm.

A total length of the insert 500 measured in an axial direction may be at least 6 mm, at least 7 mm, at least 8 mm, at least 9 mm, at least 10 mm, or at least 12 mm.

The exemplary embodiment of the insert 500 can also be seen in FIGS. 5, 7, 8, 9 and 10. FIG. 5 illustrates a cross-section of the hammer drill 10. FIG. 10 is a cross-section of a portion of the hammer drill 10 including the insert 500. FIGS. 7 and 8 are perspective views of the insert 500 molded into the clutch housing 300. FIG. 9 is a perspective view of the insert 500, clutch housing 300 fixed ratchet 110, clutch adjustment collar 31 and clutch spring 32.

As shown in, for example, the cross-sectional views of FIGS. 5 and 10, the generally cylindrical body 510 of the insert 500 is around the output spindle 200. A bearing 81 may be between the insert 500 and the output spindle 200. As discussed above, the insert 500 is insert molded into the clutch housing 300 which is fixed with respect to the tool housing 16 and remains stationary as the output spindle 200 rotates when driven by the motor 50. As shown in FIGS. 5 and 10, the generally cylindrical body 510 of the insert 500 is disposed behind the cam ring 140. The cross-sectional view goes through one leg 520 of the insert. In the example embodiment, the other legs 520 extend in the same way as the leg shown in cross-section. As shown, the leg 520 extends past to the body of the cam ring 140 to an area alongside and adjacent to the fixed ratchet 110 and a least partially alongside and adjacent to the rotating ratchet 120. Accordingly, the insert 500 of the example embodiment further mitigates heat generation from the hammer mechanism. In particular, due to the material properties of the insert 500, the insert 500 helps to alleviate melting of the plastic clutch housing 300 and avoid the situation where one or more part so the hammer mechanism melts into the clutch housing 300. For example, the insert 500 may serve as a buffer between the fixed ratchet 110 and the clutch housing 300 and may help to prevent the fixed ratchet 110 from melting into the clutch housing 300.

In the example embodiment, the clutch housing 300 is made of a first material with a first melting point and the insert 500 is made of a second material with a second melting point higher than the first melting point. In an example embodiment, the clutch housing 300 may be made of a glass filled nylon material. In the example embodiment, the clutch housing 300 is made of glass filled nylon and may have a deformation point of approximately 220 degrees Celsius and a melting point of approximately 262 degrees Celsius. The clutch housing 300 may begin to cause failures in the tool 10 if it begins to deform and so problems or failures may occur before the melting point is reached. The insert 500 may be made of a powdered metal and may have a deformation point and melting point well above that of the clutch housing. For example, the insert may have a melting point above 800 degrees Celsius compared to the clutch housing 300 having a melting point of approximately 262 degrees Celsius.

In an embodiment, the second melting point may be at least 100 degrees Celsius higher than the first melting point; at least 200 degrees Celsius higher than the first melting point; at least 300 degrees Celsius higher than the first melting point; at least 400 degrees Celsius higher than the first melting point; at least 500 degrees Celsius higher than the first melting point; at least 600 degrees Celsius higher than the first melting point; at least 700 degrees Celsius higher than the first melting point. In an embodiment, the second material may have a deformation point at least 100 degrees Celsius higher than the deformation point of the first material; at least 200 degrees Celsius higher than the deformation point of the first material; at least 300 degrees Celsius higher than the deformation point of the first material; or at least 400 degrees Celsius higher than the deformation point of the first material.

FIGS. 7 and 8 illustrate the clutch housing 300 with the insert 500 insert molded into the clutch housing 300. One leg 520 is shown in FIGS. 7 and 8. As shown, the leg 520 forms a part of one side of the groove 330. In particular, the side surface 524 of leg 520 shown in FIG. 4 forms a part of one side of the groove 330. Accordingly, as shown in FIG. 9, the leg 520 abuts the projections 114 of the fixed ratchet 110 in the groove 330. Although only one leg 520 is visible in FIGS. 7 and 8, the other two legs 520 are disposed in the same manner. That is, each leg 520 forms a part of a side of each of the grooves 330.

FIG. 9 illustrates the clutch housing 300 with the insert 500 insert molded into the clutch housing 300. As discussed, projections 114 of the fixed ratchet 110 engage with the grooves 330 of the clutch housing 300. Also, legs 520 of the insert 500 form at least part of a side of the grooves 330. Accordingly, the projections 114 of the fixed ratchet 110 abut the legs 520 of the insert 500, particularly at the sides 542 of the legs 520. Other portions of the fixed ratchet 110 are also adjacent to portions of the legs 520.

In the example embodiment, the rotating ratchet 130 is driven in the direction A shown in FIG. 9. Accordingly, the fixed ratchet 110 is repeatedly driven into the side of the groove 330 formed at least partially by the legs 520. Locating the legs 520 in this area may provide particularly good heat resistance, dissipation and resistance of deformation. In other example embodiments, legs may additionally or alternatively be on the other side of the grooves.

As shown in FIGS. 7 and 8, a contour of the legs 520 are shaped to match contours of the clutch housing 300. For example, the clutch housing has an inner surface 340 that is generally cylindrical. The inner surface 340 includes a tapered section 341. The tapered section 341 matches the tapered portion 523 of the legs 520. Similarly, the side surface 524 may smoothly form part of the side of the groove 330.

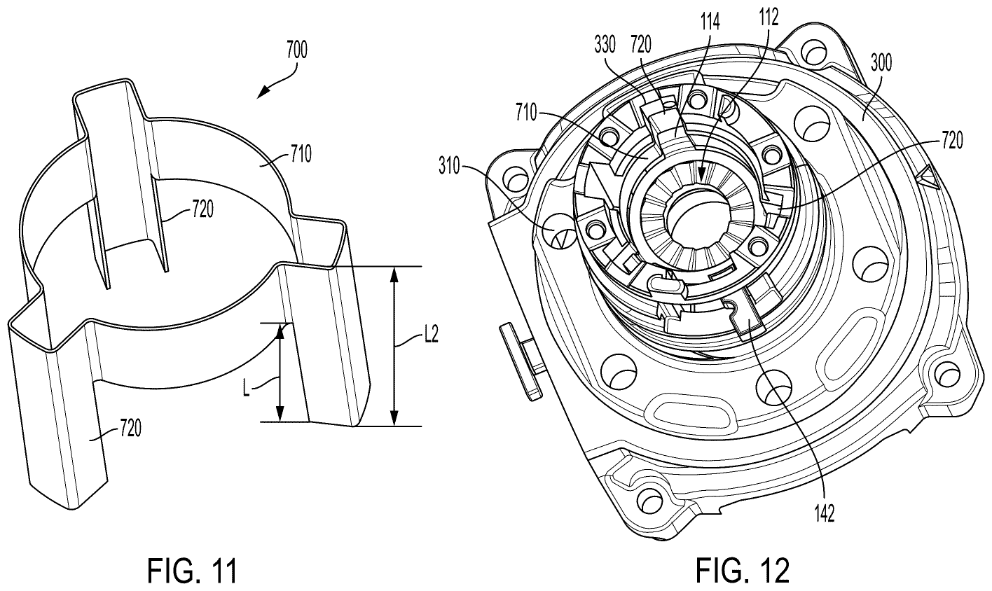

FIGS. 11 and 12 illustrate another example embodiment of an insert 700. The insert 700 includes a generally cylindrical insert body 710 and projections 720, in this case legs 720. In the example embodiment, the insert body 710 is disposed in the clutch housing 300 and the legs 720 of the insert 700 project rearwardly from the insert body 710. That is, the legs 720 project in a direction rearwardly away from the chuck 30 and towards the motor. In other example embodiments, the insert 700 may positioned in a similar manner as the insert 500 such that the insert body of the insert 700 would be behind the cam ring and legs of the insert would project in a forward direction.

In the example embodiment of FIGS. 11 and 12, each of the legs 720 of the insert 700 are aligned with a groove 330 of the clutch housing 300. A significant part of or all of the groove 330 is operably covered by the legs 720. Accordingly, the projections 114 of the fixed ratchet 114 have running contact with the legs 720 and so the material of the insert 700 abuts the fixed ratchet 114 and can dissipate heat. In example embodiments, the insert 700 may including melting point and deformation properties the same as or similar to that of insert 500. Accordingly, the insert 700 may have a material with a melting point and a deformation point that is much higher than the clutch housing 300. Since the insert 700 has a melting and deformation point higher than the clutch housing 300, the insert 700 provides a buffer between the fixed ratchet 110 and the clutch housing 300. This may help prevent deformation of the clutch housing 300 or the fixed ratchet 110 melting into the clutch housing 300.

In embodiments, the insert 700 may be stamped metal. Making the insert 700 out of stamped metal may decrease the amount of material required for the insert 700. In an example embodiment, the insert 700 may be press fit into the clutch housing 300. In an example embodiment, an adhesive may fix the insert 700 to the clutch housing 300.

The insert 700 of example embodiments may include material properties and other features the same as or similar to the insert 500. For example, the insert 700 may include relative melting portion and deformation point properties corresponding to those of the second material discussed above. Additionally, similar to the legs 520, the legs 720 may have a projection length L in an direction extending away from the generally cylindrical body 710. The length L of the legs may be at least 4 millimeters (mm), at least 5 mm, at least 6 mm, at least 7 mm, at least 8 mm, at least 9 mm, or at least 10 mm. The legs 720 may also have an overall length L2. The length L2 may be greater than the length L and the length L2 may be at least 6 mm, at least 7 mm, at least 8 mm, at least 9 mm, at least 10 mm or at least 11 mm.

Also, a total length of the insert 700 measured in an axial direction may be at least 6 mm, at least 7 mm, at least 8 mm, at least 9 mm, at least 10 mm, or at least 12 mm.

In the example embodiment, the clutch housing 300 has three grooves 330. In other embodiments, the clutch housing 300 may have a greater or fewer number of grooves 330, such as two grooves, at least four grooves, or at least five grooves. The number of projections 520, 720 may correspond to the number of grooves 330. In other embodiments, the number of projections 520 may be greater than the number of grooves 330 or less than the number of grooves 330.

The foregoing description of the embodiments has been provided for purposes of illustration and description. It is not intended to be exhaustive or to limit the disclosure. Individual elements or features of a particular embodiment are generally not limited to that particular embodiment, but, where applicable, and can be combined, added to or exchanged with features or elements in other embodiments. The same may also be varied in many ways. Such variations are not to be regarded as a departure from the disclosure, and all such modifications are intended to be included within the scope of the disclosure.

Additionally, while exemplary embodiments are described with respect to an oscillating tool, the methods and configurations may also apply to or encompass other power tools such as other tools that hold power tools accessories.

What is claimed is:

1. A hammer drill, comprising:
a tool housing comprising a motor housing portion;
a motor in the motor housing portion;
an output spindle driven by the motor;
a clutch housing;
a hammering mechanism comprising a first ratchet and a second ratchet, the hammering mechanism configured to impart axial impacts to the output spindle; and
an insert in the clutch housing;
wherein the insert comprises a body disposed around the spindle and a plurality of legs extending from the body.

2. The hammer drill of claim 1, wherein the clutch housing comprises a first material with a first melting point,
wherein the insert comprises a second material with a second melting point; and
wherein the second melting point is higher than the first melting point.

3. The hammer drill of claim 2, wherein the second melting point is at least 200 degrees Celsius higher than the first melting point.

4. The hammer drill of claim 2, wherein the second melting point is at least 400 degrees Celsius higher than the first melting point.

5. The hammer drill of claim 3, wherein the plurality of legs have a projection length of at least five millimeters.

6. The hammer drill of claim 3, wherein the clutch housing comprises a longitudinally extending groove;
wherein the insert forms at least a part of a sidewall of the longitudinally extending groove; and
wherein the first ratchet comprises a first ratchet projection and the first ratchet projection engages the longitudinally extending groove.

7. The hammer drill of claim 3, wherein the clutch housing comprises a longitudinally extending groove; and
wherein the insert covers at least a part of the longitudinally extending groove.

8. The hammer drill of claim 3, wherein the first ratchet is rotationally fixed relative to the clutch housing; and
wherein the plurality of legs extend in a forward direction to an area adjacent to the first ratchet.

9. The hammer drill of claim 1, wherein the plurality of legs have a projection length of at least five millimeters.

10. A hammer drill, comprising:
a tool housing comprising a motor housing portion;
a motor in the motor housing portion;
an output spindle driven by the motor;
a clutch housing;
a hammering mechanism comprising a first ratchet rotationally fixed relative to the clutch housing and a second ratchet fixed to the output spindle, the hammering mechanism configured to impart axial impacts to the output spindle; and
an insert in the clutch housing;
wherein the clutch housing comprises a first material with a first melting point;
wherein the insert comprises a second material with a second melting point;
wherein the second melting point is at least 200 degrees Celsius greater than the first melting point; and
wherein at least a portion of the insert is in an area adjacent to the first ratchet.

11. The hammer drill of claim 10, wherein the fixed ratchet comprises a fixed ratchet projection, the fixed ratchet projection extending radially outwardly and configured to limit radial movement of the fixed ratchet; and
wherein at least a portion of the insert is in an area adjacent to the fixed ratchet projection.

12. The hammer drill of claim 10, wherein the clutch housing comprises a longitudinally extending groove; and
wherein the insert forms at least a part of a sidewall of the longitudinally extending groove.

13. The hammer drill of claim 10, further comprising a cam ring behind the first rachet; and
wherein at least a portion of the insert is in an area behind the cam ring.

14. The hammer drill of claim 10, wherein the insert comprises a generally cylindrical body and at least one projection that projects forward from the generally cylindrical body; and
wherein the generally cylindrical body is around a portion of the output spindle.

15. The hammer drill of claim 10, wherein the insert is made of at least one of powdered metal or sheet metal.

16. A hammer drill, comprising:
a tool housing comprising a motor housing portion;
a motor in the motor housing portion;
an output spindle driven by the motor;
a clutch housing;
a hammering mechanism comprising a cam ring, a first ratchet rotationally fixed relative to the clutch housing, and a second ratchet fixed to the output spindle, the hammering mechanism configured to impart axial impacts to the output spindle;
an insert in the clutch housing;
wherein the insert comprises a generally cylindrical body and at least one projection extending forward from the generally cylindrical body with a projection length of at least five millimeters;
wherein the generally cylindrical body is around a portion of the output spindle and behind the cam ring; and
wherein the at least one projection extends forward at least as far as the first ratchet.

17. The hammer drill of claim 16, wherein the at least one projection comprises a plurality of legs.

18. The hammer drill of claim 16, wherein the clutch housing comprises a first material with a first melting point;
wherein the insert comprises a second material with a second melting point;
wherein the second melting point is at least 200 degrees Celsius greater than the first melting point.

19. The hammer drill of claim 18, wherein the clutch housing comprises a longitudinally extending groove.
wherein the at least one projection of the insert forms at least a part of a sidewall of the longitudinally extending groove.

20. The hammer drill of claim 19, wherein the fixed ratchet comprises a ratchet projection and the ratchet projection engages the longitudinally extending groove.
